(19) United States
(12) Patent Application Publication
(10) Pub. No.: US 2003/0039243 A1
(43) Pub. Date: Feb. 27, 2003

(54) Technique for creating a fault-tolerant daisy-chained serial bus

(76) Inventor: Jon A. Parker, Santa Clara, CA (US)

Correspondence Address: Noel F. Heal, TRW Inc., Law Dept., One Space Park, Bldg. E2/6051, Redondo Beach, CA, 90278, US

(21) Appl. No.: 09/892,271

(22) Filed: Jun. 26, 2001

(51) Int. Cl. H04L 12/50

(52) U.S. Cl. 370/362

(57) ABSTRACT

A high-speed data bus operating under the IEEE-1394 protocol is fault tolerant. The data bus includes a plurality of serial busses communicatively interconnecting a plurality of nodes. A controller selectively enables communication over the serial busses based on an operational condition of the data bus. The serial busses interconnect the nodes in a ring topology such that the data bus continues to function when the operational condition includes device faults. In a highly preferred embodiment, the serial busses are daisy-chained busses. Interconnecting the nodes in a ring topology enables reliable detection of device faults as well as a mechanism for switching between the daisy-chained busses and diagnosing the device fault.

### BACKGROUND OF THE INVENTION

1. Field of the Invention

This invention relates generally to serial busses. More particularly, the invention relates to a daisy-chained high speed data bus having a ring topology.

2. Discussion of the Related Art

Many applications require the interconnection of different pieces of equipment in order to easily and quickly share information. For example, commercial devices such as camcorders, DVD players, and digital audio equipment are often interconnected with computer equipment such as CPUs, hard drives and modems for the purpose of transferring various types of data. Other examples include on board satellite communications between devices such as instruments, computers, transponders, and mass storage units.

In order to better serve the needs of the above and other applications, serial busses have evolved under a variety of standards and protocols. An important aspect of serial bus communication is the connection of multiple devices to one another when there is a limited number of connection ports (i.e., scalability). The two most common approaches to this problem are hub-connecting and daisy-chaining. For example, the Universal Serial Bus (USB) is a hub-connected approach to serial bus communication. This means that each device connects to a common interface (the hub) to form a “wheel-and-spokes” type of configuration. The USB can connect up to 127 pieces of equipment (or devices) and has a data transfer rate of approximately 12 Mbps. While the USB is acceptable for certain applications and is relatively inexpensive, it is generally accepted that for applications requiring relatively high data throughput, other approaches are preferred.

One such alternative is (a registered mark of Apple). FireWire® was originally created by Apple and was standardized in 1995 as the specification IEEE-1394 High Performance Serial Bus. FireWire® busses are daisy-chained as opposed to hub-connected in the case of the USB. Conventional approaches to interconnecting a plurality of nodes in accordance with IEEE-1394 therefore involve “stringing” together the devices of interest. While FireWire® busses provide a data transfer rate of approximately 400 Mbps per second, a number of difficulties still remain.

One particular difficulty relates to fault tolerance. Fault tolerance is used herein to describe the ability of the data bus to continue to function when a device fault is present. Currently, data busses operating in accordance with IEEE-1394 have no mechanism for detecting, recovering from, or diagnosing device faults. This shortcoming can be particularly critical in military and aerospace applications such as on-board satellite communication applications. This is due in large part to the fact that IEEE-1394 requires that the nodes be connected in a tree-based topology. Thus, the “ends” or leaf nodes of the conventional daisy-chained serial bus limit the functionality of the overall data bus. It is therefore desirable to provide a high speed data bus that continues to function when a device fault is present. It is highly desirable that the data bus have the relatively high transfer rates outlined in IEEE-1394.

### SUMMARY OF THE INVENTION

The above and other objectives are achieved by a high speed data bus and a method in accordance with the present invention. The data bus includes a plurality of serial busses communicatively interconnecting a plurality of nodes. A controller selectively enables communication over the serial busses based on an operational condition of the data bus. The serial busses interconnect the nodes in a ring topology such that the data bus continues to function when the operational condition includes a device fault. In a highly preferred embodiment, the serial busses are daisy-chained busses. Interconnecting the nodes in a ring topology enables reliable detection of device faults as well as a mechanism for switching between the daisy-chained busses and diagnosing the device fault.

Further in accordance with the present invention, a method for communicatively interconnecting a plurality of nodes to form a high speed data bus is provided. The method includes the step of interconnecting the nodes with a first serial bus in a daisy-chain configuration having a first end and a second end. The nodes are further interconnected with a second serial bus in the daisy-chain configuration. The method further provides for connecting the first end to the second end such that the serial busses form a ring topology.

In another aspect of the invention, a method for selectively enabling communication over a plurality of serial busses is provided. The serial busses are connected in a ring topology and the method includes the step of detecting a device default. The device fault interrupts communication over a first serial bus. The method further provides for switching the communication from the first serial bus to a second serial bus in response to detection of the device fault. The device fault is then identified while communication is switched to the second serial bus.

### BRIEF DESCRIPTION OF THE DRAWINGS

Additional objects, features and advantages of the present invention will become apparent from the following description and the appended claims when taken in connection with the accompanying drawings, wherein:

FIG. 1 is a block diagram showing a high speed data bus according to the present invention;

FIG. 2 is a block diagram showing dedicated power supplies according to the present invention;

FIG. 3 is a block diagram showing the creation of isolated fault zones according to the present invention;

FIG. 4 is a state diagram demonstrating operation of a controller according to one embodiment of the present invention;

FIG. 5 is a flow diagram demonstrating fault tolerance according to one embodiment of the present invention;

FIG. 6 is a block diagram showing a data bus communicating over a first daisy-chained bus in a first direction according to one embodiment of the present invention;

FIG. 7 is a block diagram showing the occurrence of a device failure in the data bus illustrated in FIG. 6;

FIG. 8 is a block diagram demonstrating communication over a second daisy-chained bus in the first direction according to one embodiment of the present invention; and

FIG. 9 is a block diagram showing a device failure in the data bus illustrated in FIG. 8.

### DETAILED DESCRIPTION OF THE PREFERRED EMBODIMENTS

The following discussion of the preferred embodiments directed to a high speed data bus is merely exemplary in nature, and is in no way intended to limit the invention or its applications or uses.

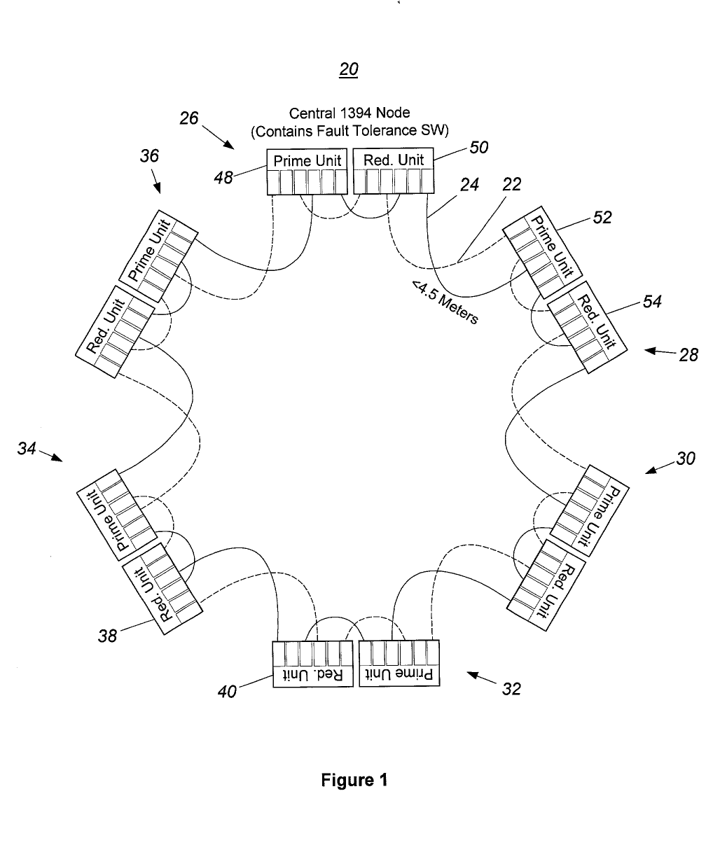

Turning now to FIG. 1, a high speed data bus in accordance with the present invention is shown generally at 20. The data bus 20 has a plurality of serial busses 22, 24 communicatively interconnecting a plurality of nodes 26, 28, 30, 32, 34, and 36. While six nodes are shown here, it will be appreciated that the present invention can readily be scaled to include either a greater or lesser number of nodes. As will be discussed in greater detail below, node 26 is selected as the central node and contains additional fault tolerance software (i.e., a controller). The remaining nodes 28, 30, 32, 34, 36, however, contain little or no fault tolerance software. Thus, the data bus 20 further includes a controller for selectively enabling communication over the serial busses 22, 24 based on an operational condition of the data bus 20. The serial busses 22, 24 interconnect the nodes 26, 28, 30, 32, 34, 36 in a ring topology such that the data bus 20 continues to function when the operational condition includes a device fault. The data bus 20 is therefore fault tolerant. As will be discussed in greater detail below, the fault tolerance of the data bus 20 represents a significant improvement over conventional high speed data busses.

It is important to note that in the preferred data bus 20, the serial busses 22, 24 are daisy-chained busses. Thus, the serial busses include a first daisy-chained serial bus 22 and a second daisy-chained serial bus 24. While the preferred embodiment is primarily concerned with busses operating under the IEEE-1394 protocol (or FireWire®), other protocols can also benefit from the fault tolerance of the present invention. In this regard, it can be seen that, unlike traditional daisy-chained busses, the present invention connects the “ends” of the bus to form the ring topology. For example, it can be seen that the nodes 26, 28, 30, 32, 34, 36 are interconnected with the first daisy-chained serial bus 22 in a daisy-chain configuration having a first end 38 and a second end 40. The first end 38 is the primary unit of node 34, and the second end is the redundant unit of node 32. The ends 38, 40 have been arbitrarily selected and can be viewed as being located anywhere around the ring. Similarly, the nodes 26, 28, 30, 32, 34, 36 are interconnected with the second daisy-chained serial bus 24 in the daisy-chain configuration. The resulting ring topology has a number of advantages over conventional topologies. For example, the ring topology allows every node except one (the central node) in the ring to contain little or no fault tolerance software. Furthermore, the ring topology enables simplified cable and harness rooting with four cables being extended between each unit (not including power). It will also be appreciated that the ring topology has increased reliability when compared to a simple tree topology.

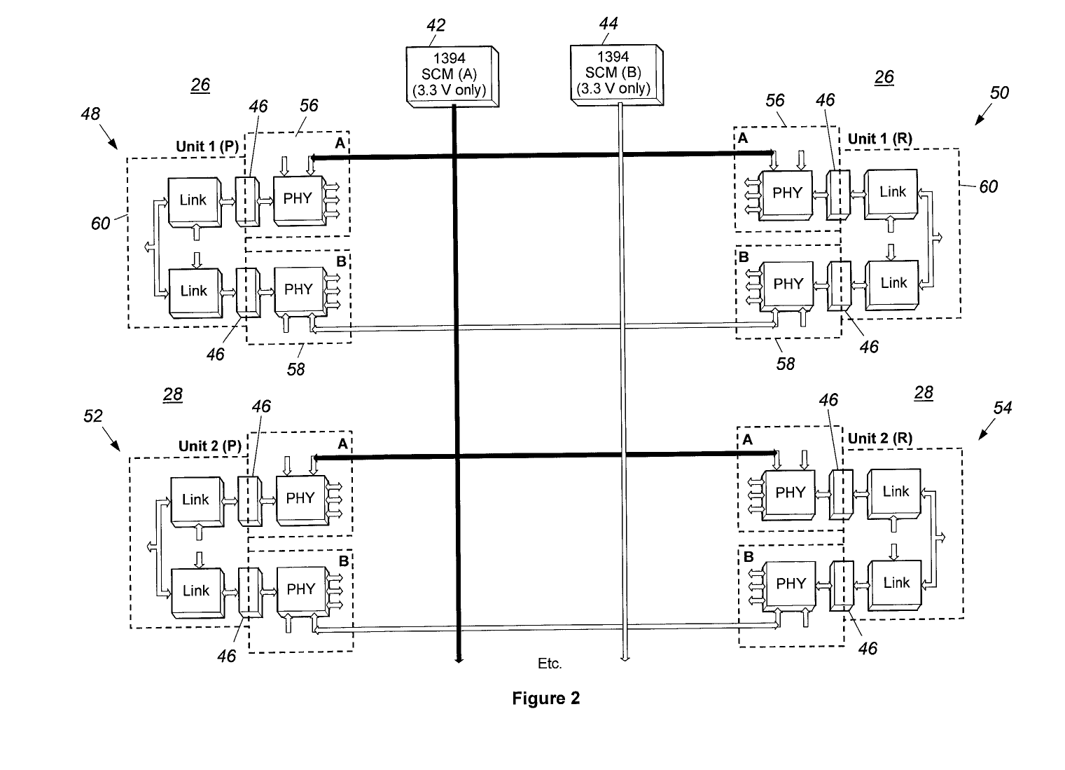

As noted above, each node has a primary unit and a redundant unit. Each unit has a physical (PHY) layer and a link layer. Under the present invention, the physical layer is divided into a Bus A portion and a Bus B portion as shown in FIG. 2. In order to maintain complete fault isolation between the A and B PHY layers, separate power supplies must be used for each bus. Power to the link layer in each node is provided by each individual unit. FIG. 2 demonstrates the preferred power supply approach to the present invention. It can be seen that the data bus further includes a plurality of dedicated power supplies 42, 44 corresponding to the plurality of daisy-chained serial busses for providing isolated power to the daisy-chained serial busses. Thus, the first power supply 42 provides power to the first daisy-chained serial bus (Bus A) PHY layer, while the second power supply 44 provides power to the second daisy-chained serial bus (Bus B) PHY layer. The power for Bus A is therefore isolated from the power for Bus B. It can further be seen that isolation components 46 are connected between physical layers and link layers of the nodes such that each daisy-chained bus defines an isolated physical layer fault zone. Thus, device faults occurring within a fault zone cannot propagate into, and therefore do not affect, other fault zones.

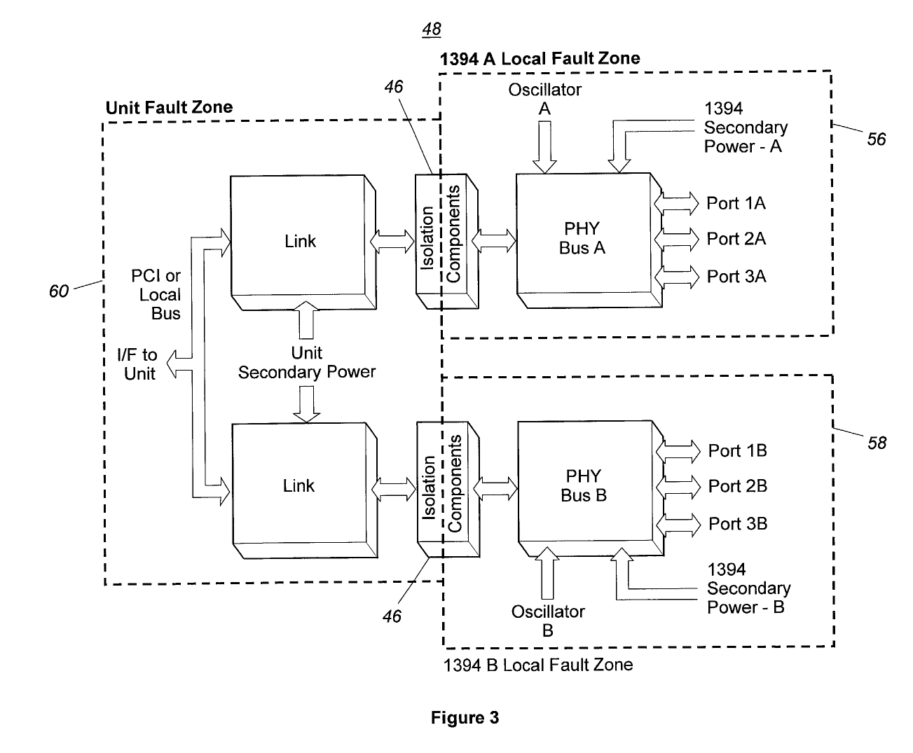

The above concept is shown in greater detail in FIG. 3. Here the primary unit 48 of node 26 is shown to have a Bus A fault zone 56, a Bus B fault zone 58, and a unit fault zone 60. Returning now, to FIG. 2, it can be seen that similar fault zones exist for the redundant unit 50 of node 26, the primary unit 52 of node 28, the redundant unit 54 of node 28, and so on. It will also be appreciated that since redundant units are used, redundant PHY interfaces to the remainder of the unit are in power off mode during normal operation. When device failures occur, however, these interfaces can be considered in generating future configurations. Furthermore, the link interfaces of each unit receive power from the unit SCM. Reliability of the unit SCM is not included in the 1394 ring reliability prediction. With regard to the isolation components 46, it is known that transformers can be utilized between the PHY and link layer chips to create a bus that can continue to pass data when it's link is powered off.

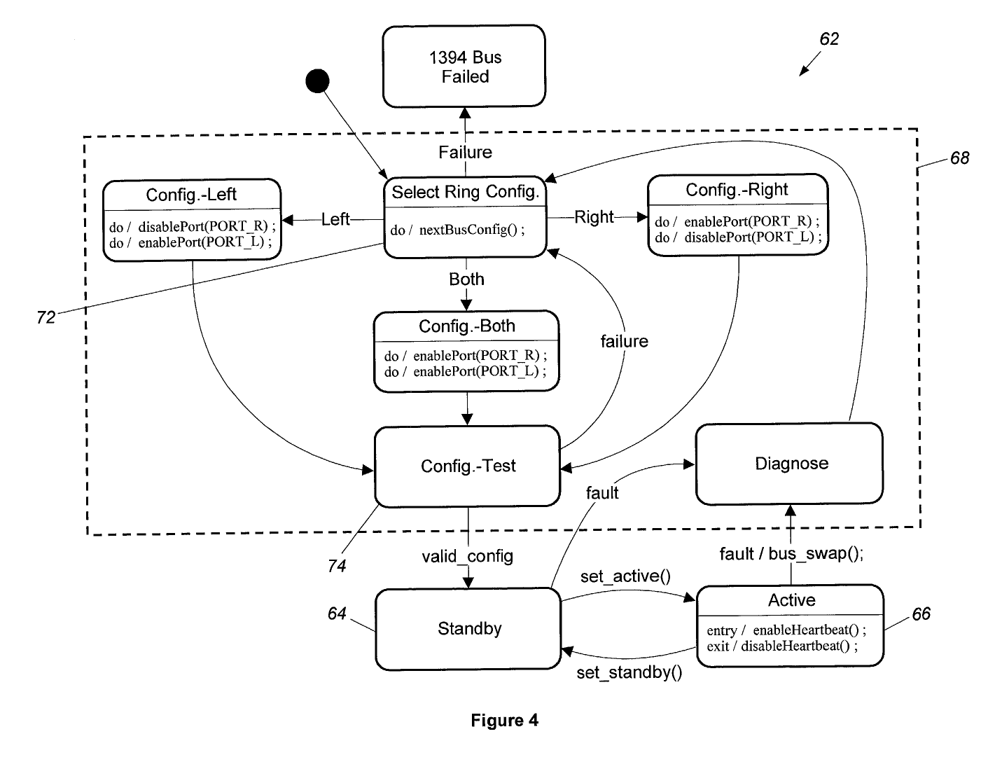

Turning now to FIG. 4, the functions of the controller 62 will be described in greater detail. Generally, a detection module 64 detects the device fault, where the device fault interrupts communication over one of the daisy-chained busses. The following example will use the first daisy-chained serial bus as the initially active bus for purposes of discussion. A recovery module 66 switches communication from the first daisy-chained serial bus to the second daisy-chained serial bus in response to detection of the device fault. A diagnosis module 68 identifies the device fault while the communication is switched to the second daisy-chained serial bus. The controller further includes a continuous pulse transceiver for transmitting and receiving a continuous pulse over the daisy-chained busses, where the device fault causes an interruption in the continuous pulse transmitted over the first daisy-chained serial bus. The diagnosis module 68 preferably includes a configuration switch 72 for stepping through possible configurations of the first daisy-chained serial bus. A test module 74 determines whether configurations are valid.

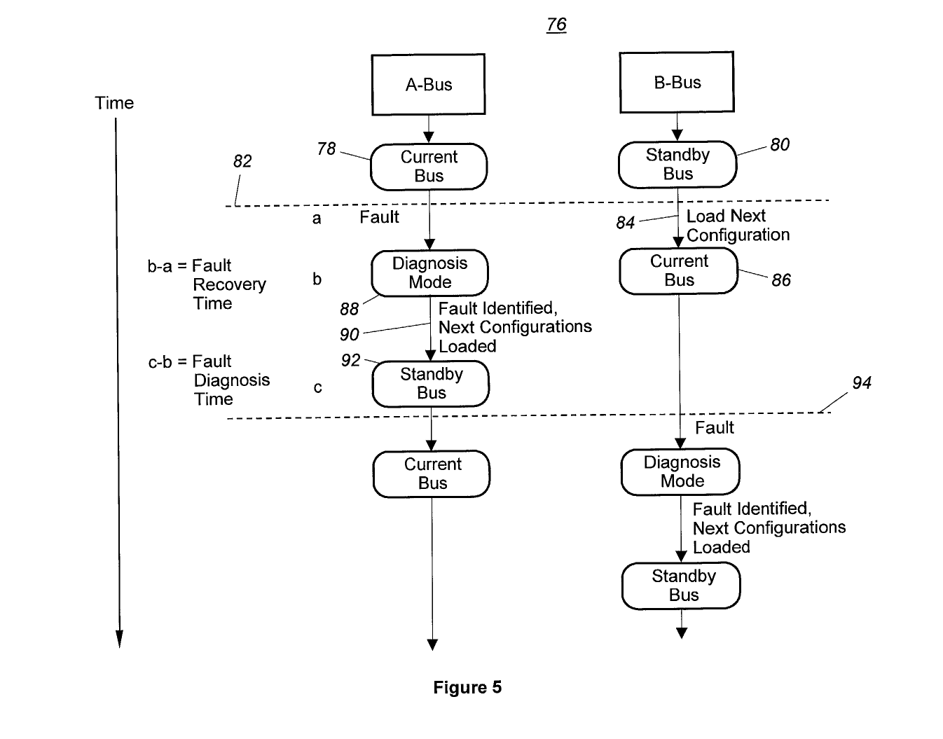

Turning now to FIG. 5, operation of the above example is shown in a flow diagram 76. Specifically, it can be seen that a current bus is selected at step 78 and a standby bus is selected at step 80. At step 82 a device fault is detected. This causes the next configuration to be loaded at step 84 for the former standby bus. Thus, at step 86 a new current bus is selected and at step 88 the former current bus enters diagnosis mode. Once the fault is identified, the next configuration for Bus A is loaded at step 90. Thus, at step 92 Bus A is placed in standby mode. Upon detection of another fault at step 94, the above sequence is repeated.

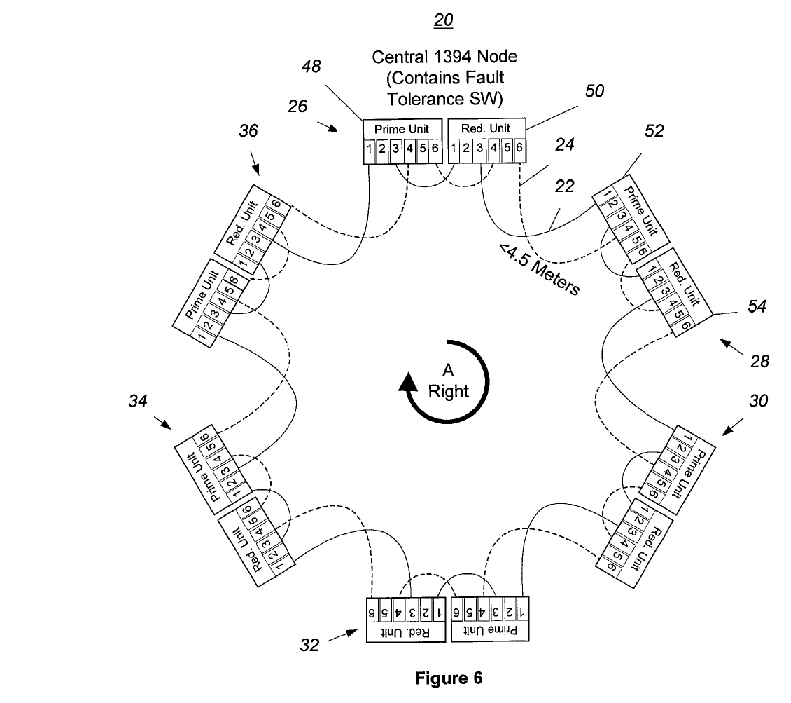

FIGS. 6-9 further illustrate the operation of the preferred data bus 20. Specifically, FIG. 6 illustrates communication over the first daisy-chained serial bus 22 (or Bus A) in a “right” configuration. The second daisy-chained serial bus 24 is in standby mode and is therefore shown with dotted lines.

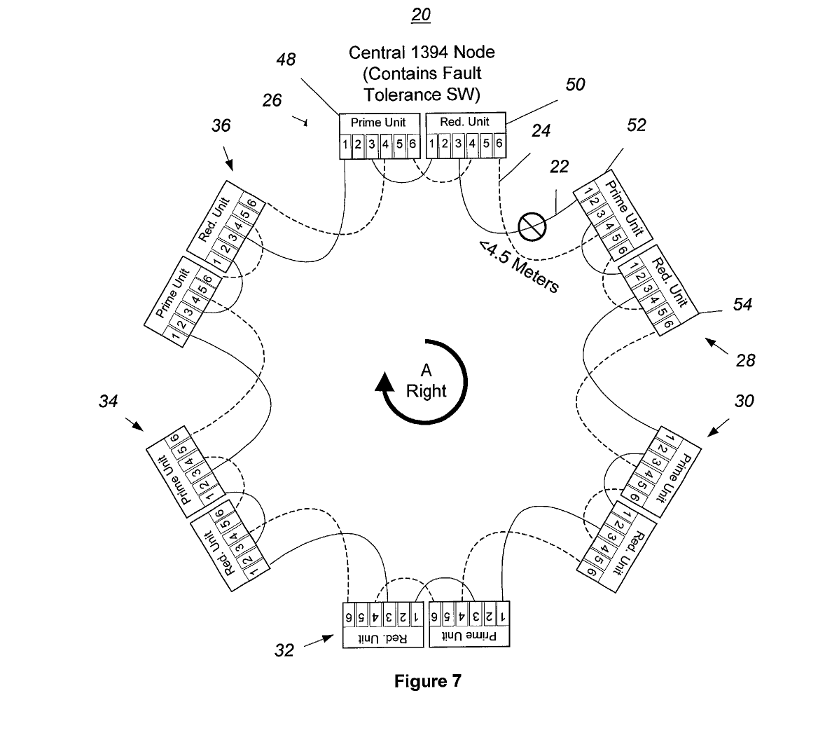

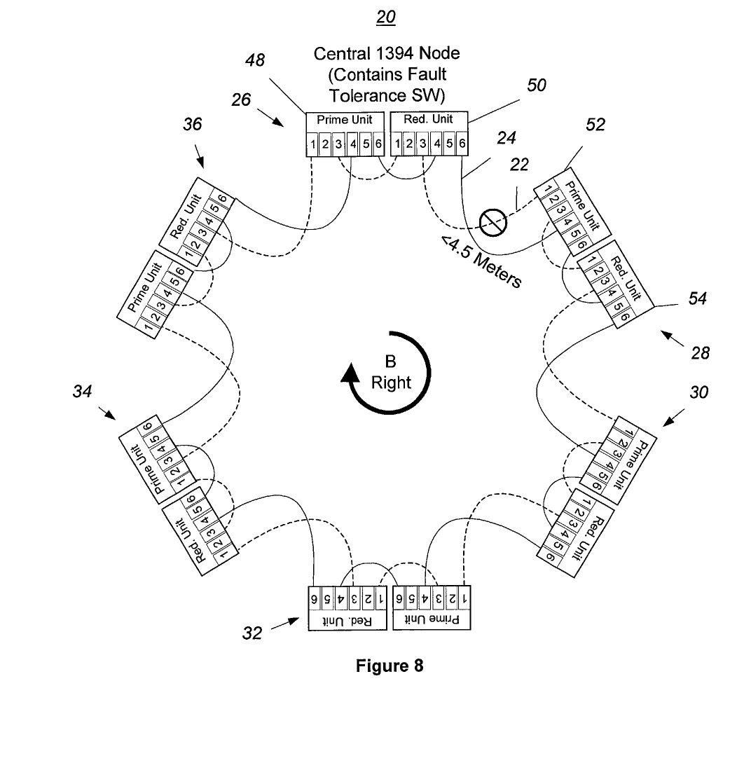

FIG. 7 illustrates the occurrence of a fault in the cabling between the redundant unit 50 of node 26 and the primary unit 52 of node 28. It will be appreciated that the illustrated device failure is only one of a multitude of possible failures from which the data bus 20 is immune. Turning now to FIG. 8, it can be seen that the controller located within the central node 26 switches the second daisy-chained serial bus 24 to the active mode (in the “right” direction) and places the first daisy-chained serial bus 22 in the diagnosis mode. Once the fault is identified, the next operable configuration for the first daisy-chained serial bus 22 is loaded and the bus is placed in standby mode.

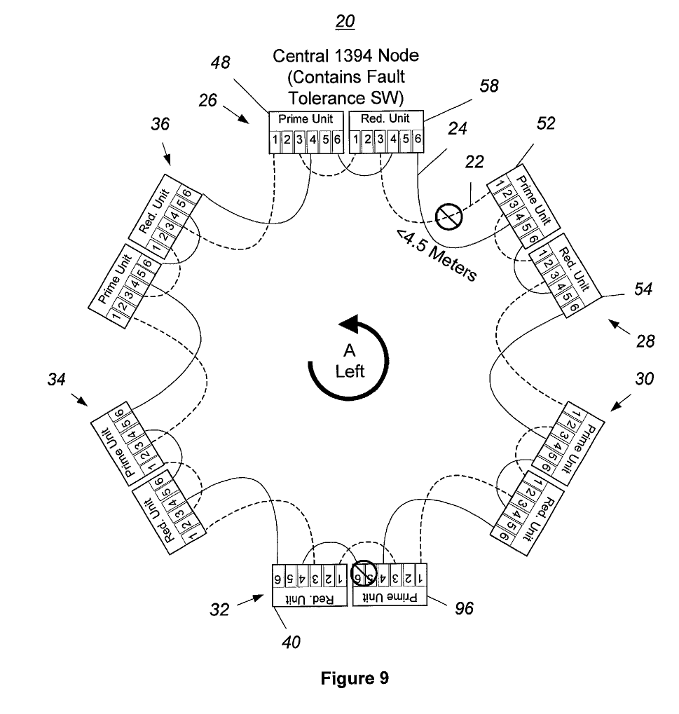

FIG. 9 demonstrates operation of the data Bus 20 when a second fault occurs in the primary unit 96 of node 32. In this case, Bus A will be configured to communicate in the “left” direction. As already noted, the data bus 20 contemplates a wide variety of device failures. For example, potential device failures include but are not limited to physical layer power failures, propagated failures in one of the daisy-chained busses, and link layer device failures in one of the nodes.

The above-described data bus 20 is stand alone and requires no support for data transfer from any other interfaces. This approach also enables rapid recovery from faults and allows for fault-diagnosis and bus reconfiguration in the background while normal operation continues. Reconfiguring from a central node simplifies the design of other nodes on the bus. Thus, by modifying conventional IEEE-1394 daisy-chained busses, fault tolerance is achievable. The present invention can be used as a payload/spacecraft high-speed serial bus on Integrated Avionics. Other high-speed applications can also benefit from the present invention.

It is important to note that the IEEE-1394 standard limits cable runs between 100 Mbps/400 Mbps nodes to 4.5 meters. This length is based on timing margins for 400 Mbps operation and has a substantial margin for 100 Mbps operation. Thus, the present invention can be maximized in length capability by characterizing the required lengths for 100 Mbps operation. Furthermore, should they become necessary, repeater nodes may be used.

With regard to data latency, analysis indicates that data latency can be bounded to 125 μs through the use of synchronous transfers. Thus, IEEE-1394 data latency performance exceeds the requirements for the existing architecture. With regard to the connections between nodes, connectors are available from a number of sources, including AMP, Cristek, and commercial.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A high speed data bus comprising:
a plurality of serial busses communicatively interconnecting a plurality of nodes; and
a controller for selectively enabling communication over the serial busses based on an operational condition of the data bus;
said serial busses interconnecting the nodes in a ring topology such that the data bus continues to function when the operational condition includes a device fault.

2. The data bus of claim 1 wherein the serial busses are daisy-chained busses.

3. The data bus of claim 2 further including:
a plurality of dedicated power supplies corresponding to the plurality of daisy-chained busses for providing isolated power to the daisy-chained busses; and
isolation components connected between physical layers and link layers of the nodes such that each daisy-chained bus defines an isolated physical layer fault zone.

4. The data bus of claim 2 wherein the controller includes:
a detection module for detecting the device fault, the device fault interrupting communication over a first daisy-chained bus;
a recovery module for switching communication from the first daisy-chained bus to a second daisy-chained bus in response to detection of the device fault; and
a diagnosis module for identifying the device fault while the communication is switched to the second daisy-chained bus.

5. The data bus of claim 4 wherein the controller further includes a continuous pulse transceiver for transmitting and receiving a continuous pulse over the daisy-chained busses, the device fault causing an interruption in the continuous pulse transmitted over the first daisy-chained bus.

6. The data bus of claim 5 wherein the device failure is a physical layer power failure for the first daisy-chained bus.

7. The data bus of claim 5 wherein the device failure is a propagated failure in the first daisy-chained bus.

8. The data bus of claim 5 wherein the device failure is a link layer device failure in one of the nodes.

9. The data bus of claim 4 wherein the diagnosis module includes:
a configuration switch for stepping through possible configurations of the first daisy-chained bus; and
a test module for determining whether configurations are valid.

10. The data bus of claim 2 wherein the controller is contained within one of the nodes.

11. A method for communicatively interconnecting a plurality of nodes to form a high speed data bus, the method comprising the steps of:
interconnecting the nodes with a first serial bus in a daisy-chain configuration having a first end and a second end;
interconnecting the nodes with a second serial bus in the daisy-chain configuration; and
connecting the first end to the second end such that the serial busses form a ring topology.

12. The method of claim 11 further including the step of selectively enabling communication over the serial busses based on an operational condition of the data bus.

13. The method of claim 12 further including the steps of:
detecting a device fault, the device fault interrupting communication over the first serial bus;
switching communication from the first serial bus to the second serial bus in response to detection of the device fault; and
identifying the device fault while communication is switched to the second serial bus.

14. The method of claim 13 further including the steps of:
transmitting a continuous pulse over the first serial bus in a first direction around the ring topology;
receiving the continuous pulse from a second direction when the first serial bus is operating without device faults; and
detecting an interruption in the continuous pulse when the device fault occurs.

15. The method of claim 11 further including the step of using daisy-chained busses for the serial busses.

16. A method for selectively enabling communication over a plurality of serial busses, wherein the serial busses are connected in a ring topology, the method comprising the steps of:
detecting a device fault, the device fault interrupting communication over a first serial bus;
switching communication from the first serial bus to a second serial bus in response to detection of the device fault; and
identifying the device fault while communication is switched to the second serial bus.

17. The method of claim 16 further including the steps of:
transmitting a continuous pulse over the first serial bus in a first direction around the ring topology;
receiving the continuous pulse from a second direction when the first serial bus is operating without device faults; and
detecting an interruption in the continuous pulse when the device fault occurs.
